(19) United States
(12) Patent Application Publication
(10) Pub. No.: US 2026/0331633 A1
(43) Pub. Date: Oct. 22, 2026

(54) BATTERY APPARATUS AND POWER CONSUMING APPARATUS

(71) Applicant: CONTEMPORARY AMPEREX TECHNOLOGY CO., LIMITED, Ningde (CN)

(72) Inventors: Ruitong ZHANG, Ningde (CN); Wenli WANG, Ningde (CN); Tianyue YUAN, Ningde (CN); Xiaoshan DAI, Ningde (CN); Heyuan LI, Ningde (CN); Caigui LI, Ningde (CN)

(73) Assignee: CONTEMPORARY AMPEREX TECHNOLOGY CO., LIMITED, Ningde (CN)

(21) Appl. No.: 19/557,216

(22) Filed: Mar. 5, 2026

Related U.S. Application Data
(63) Continuation of application No. PCT/CN2025/090201, filed on Apr. 21, 2025.

(51) Int. Cl. H01M 10/6555; H01M 10/615; H01M 50/204

(52) U.S. Cl. CPC H01M 10/6555; H01M 10/615; H01M 50/204

(57) ABSTRACT

A battery apparatus includes a box body assembly, a thermal management assembly, and a battery assembly. The battery assembly includes a plurality of battery layers stacked along a height direction of the battery apparatus. The plurality of battery layers are disposed in the box body assembly. The thermal management assembly includes a heat exchange member and a heating member. The heat exchange member has at least one medium flow channel therein. The at least one medium flow channel is configured for conduction of a heat exchange medium. The heat exchange medium is configured to perform heat exchange with the battery layer. The heat exchange member is disposed between the plurality of battery layers. The heating member is disposed between the battery layer and the heat exchange member, or the heating member is disposed between the battery layer and the box body assembly.

### CROSS-REFERENCE TO RELATED APPLICATION

The present application is a bypass continuation of PCT/CN2025/090201 filed on Apr. 21, 2025, which is incorporated herein by reference in its entirety.

### TECHNICAL FIELD

The present disclosure relates to the field of battery technologies, and in particular to a battery apparatus and a power consuming apparatus.

### BACKGROUND

In a new energy vehicle provided with a battery apparatus, the battery apparatus may be configured to completely or partially provide power. In a related technology, an arrangement manner of a single battery layer is used. However, a single layer of battery apparatuses may have problems of a relatively low energy density and a limited battery capacity. In addition, a relatively cold environment may cause a relatively low temperature of the battery apparatus, which may affect the cycle performance, service life, and the like of the battery apparatus.

### SUMMARY

In view of this, embodiments of the present disclosure are expected to provide a battery apparatus and a power consuming apparatus, so as to improve the cycle performance of the battery apparatus while increasing the energy density of the battery apparatus.

Therefore, a first aspect of the embodiments of the present disclosure provides a battery apparatus, including:
a box body assembly;
a battery assembly, the battery assembly including a plurality of battery layers stacked along a height direction of the battery apparatus, and the plurality of battery layers being disposed in the box body assembly; and
a thermal management assembly, the thermal management assembly including a heat exchange member and a heating member, the heat exchange member having at least one medium flow channel therein, the at least one medium flow channel being configured for conduction of a heat exchange medium, and the heat exchange medium being configured to perform heat exchange with the battery layer.

The heat exchange member is disposed between the plurality of battery layers, and the heat exchange member is configured to carry at least some of the battery layers. The heating member is disposed between the battery layer and the heat exchange member, or the heating member is disposed between the battery layer and the box body assembly.

The battery apparatus provided in this embodiment of the present disclosure includes the box body assembly, the thermal management assembly, and the battery assembly. The battery layers are disposed in the box body assembly. The box body assembly protects the battery layers. On one hand, by disposing the plurality of battery layers, it is beneficial to increasing the battery capacity of the battery apparatus. In addition, by stacking the battery layers along the height direction of the battery apparatus, it is also beneficial to fully using the space in the box body assembly, and increasing the energy density of the battery apparatus. On the other hand, by disposing the heat exchange member between the plurality of battery layers, the battery layers located on two opposite sides of the heat exchange member can exchange heat at the same time, thereby being beneficial to improving the heat exchange efficiency of the heat exchange member for the battery layers. That is, the heat exchange efficiency can also be improved while increasing the energy density of the battery apparatus. In addition, by disposing the heating member between the battery layer and the heat exchange member, or disposing the heating member between the battery layer and the box body assembly, when the battery layer needs to be heated, the heat generated by the heating member can be transferred to the battery layer, so that the battery layer can be heated under a low-temperature operating condition, thereby improving the cycle performance and service life of the battery apparatus. In addition, the structure of using the heating member to heat the battery layer is simple, and the heating apparatus does not need to be additionally disposed to heat the heat exchange medium, thereby being beneficial to simplifying the structure and reducing costs. In addition, when the heating member is disposed between adjacent battery layers, the heating member may heat the adjacent battery layers at the same time, thereby improving the heating efficiency.

In some embodiments, the plurality of battery layers include a first battery layer and a second battery layer adjacently disposed. The second battery layer is located above the first battery layer.

A first matching plane is formed on a side of the heat exchange member facing the first battery layer. The heating member is disposed between the first matching plane and the first battery layer.

In this embodiment, the first matching plane is formed on the side of the heat exchange member facing the first battery layer and the heating member is disposed between the first matching plane and the first battery layer. In this way, the heating member may be better matched with the first battery layer and the heat exchange member.

In some embodiments, the heating member is attached to the first matching plane.

Here, the heating member is attached to the first matching plane to facilitate the disposition of the heating member, so that the heating member is better attached to the heat exchange member.

In some embodiments, the heat exchange member includes at least two heat exchange plates. The heat exchange plates include a first heat exchange plate and a second heat exchange plate. A protrusion is formed by protruding from some regions of the first heat exchange plate. The first heat exchange plate and the second heat exchange plate are stacked. The medium flow channel is defined between the protrusion and the second heat exchange plate. The first matching plane is formed on a side of the second heat exchange plate facing away from the first heat exchange plate.

In this way, it is beneficial to improving the design flexibility of the heat exchange member, and a size and a path of the medium flow channel may be freely designed so as to be applicable to a complex scenario in which the heat source distribution is irregular or the space is limited, thereby being beneficial to further improving the heat exchange efficiency. In addition, at least one heat exchange plate is provided with a protrusion, so as to form a medium flow channel in the protrusion, thereby being further beneficial to improving the design flexibility.

In some embodiments, each of the battery layers includes a plurality of battery cells arranged along a first direction. The battery assembly further includes at least one end plate. The end plate is disposed at the at least one end of the battery layer along the first direction. The at least one end of the heat exchange member along the first direction is connected to the end plate. The first direction intersects with the height direction of the battery apparatus.

In this embodiment, the end plate is disposed at the at least one end of the battery layer along the first direction and the at least one end of the heat exchange member along the first direction is connected to the end plate. In this way, it is beneficial for the heat exchange member to transmit the received force to a frame through the end plate, beneficial to improving the supporting strength for the battery layer, and beneficial to reducing the possibility of extruding and damaging a lower battery layer caused by excessively stacked battery layers, thereby increasing the battery capacity of the battery apparatus and improving the reliability of the battery apparatus.

In some embodiments, a first flange portion is formed at the at least one end of the heat exchange member along the first direction. The first flange portion is connected to the end plate.

That is, the heat exchange member is folded towards the end plate to form the first flange portion, and is connected to the end plate through the first flange portion. The connection structure is simple and reliable, and is convenient to be formed.

In some embodiments, the heat exchange member is tightly connected, clamped, or welded to the end plate.

The connection structure is simple and reliable.

In some embodiments, the heating member is disposed on a top of the uppermost battery layer.

In this way, the top of the uppermost battery layer is heated, thereby further improving the reliability of the battery apparatus.

In some embodiments, the thermal management assembly further includes an upper cover. The upper cover is disposed on the top of the uppermost battery layer. The heating member is disposed between the upper cover and the uppermost battery layer.

In this embodiment, the upper cover is disposed, and the heating member is disposed between the upper cover and the uppermost battery layer, so as to facilitate the disposition of the heating member, so that the heating member is better attached to the heat exchange member, and the heating member may be protected, thereby improving the reliability of the thermal management assembly.

In some embodiments, each of the battery layers includes a plurality of battery cells arranged along a first direction. The battery assembly further includes the at least one end plate. The end plate is respectively disposed at the at least one end of the battery layer along the first direction.

A second flange portion is formed at the at least one end of the upper cover along the first direction. The second flange portion is connected to the end plate.

That is, the upper cover is folded towards the end plate to form the second flange portion, and is connected to the end plate through the second flange portion. The connection structure is simple and reliable, and is convenient to be formed.

In some embodiments, the second flange portion is tightly connected, clamped, or welded to the end plate.

The connection structure is simple and reliable.

In some embodiments, a size of the battery cell along the height direction of the battery apparatus and a size of the battery cell along the first direction are smaller than a size of the battery cell along a second direction. The first direction, the second direction, and the height direction of the battery apparatus intersect with each other. The size of the battery cell along the second direction is in a range from 300 mm to 1200 mm.

In this embodiment, the size of the battery cell along the second direction is set to be in the range from 300 mm to 1200 mm, so that both the battery capacity and assembly efficiency of the battery apparatus can be considered.

In some embodiments, each of the battery layers includes the plurality of battery cells arranged along the first direction. The battery cell further includes a terminal post and/or a pressure relief structure. The terminal post and/or the pressure relief structure is disposed on at least one side of the battery cell along the second direction. The first direction, the second direction, and the height direction of the battery apparatus intersect with each other.

In this embodiment, by disposing the terminal post and/or the pressure relief structure on the at least one side of the battery cell along the second direction, on one hand, it is beneficial to improving the structural compactness of the battery apparatus, and on the other hand, it is also beneficial to reducing the damage to the terminal post and/or the pressure relief structure in a process of the stacking battery cells and/or the battery layers.

A second aspect of the embodiments of the present disclosure provides a power consuming apparatus, including the foregoing battery apparatus.

The battery apparatus of the power consuming apparatus provided in this embodiment of the present disclosure includes a box body assembly, a thermal management assembly, and a battery assembly. Battery layers are disposed in the box body assembly. The box body assembly protects the battery layers. On one hand, by disposing the plurality of battery layers, it is beneficial to increasing the battery capacity of the battery apparatus. In addition, by stacking the battery layers along the height direction of the battery apparatus, it is also beneficial to fully using the space in the box body assembly, and increasing the energy density of the battery apparatus. On the other hand, by disposing the heat exchange member between the plurality of battery layers, the battery layers located on two opposite sides of the heat exchange member can exchange heat at the same time, thereby being beneficial to improving the heat exchange efficiency of the heat exchange member for the battery layers. That is, the heat exchange efficiency can also be improved while increasing the energy density of the battery apparatus. In addition, by disposing the heating member between the battery layer and the heat exchange member, or disposing the heating member between the battery layer and the box body assembly, when the battery layer needs to be heated, the heat generated by the heating member can be transferred to the battery layer, so that the battery layer can be heated under a low-temperature operating condition, thereby improving the cycle performance and service life of the battery apparatus. In addition, the structure of using the heating member to heat the battery layer is simple, and the heating apparatus does not need to be additionally disposed to heat the heat exchange medium, thereby being beneficial to simplifying the structure and reducing costs. In addition, when the heating member is disposed between adjacent battery layers, the heating member may heat the adjacent battery layers at the same time, thereby improving the heating efficiency.

### BRIEF DESCRIPTION OF THE DRAWINGS

FIG. 1 is a schematic structural diagram of a vehicle provided in an embodiment of the present disclosure;

FIG. 2 is a schematic structural diagram of a battery apparatus provided in an embodiment of the present disclosure;

FIG. 3 is a three-dimensional schematic exploded view of a battery apparatus provided in an embodiment of the present disclosure;

FIG. 4 is a partial three-dimensional schematic exploded view of a battery apparatus provided in an embodiment of the present disclosure;

FIG. 5 is a schematic diagram of a connection structure of a battery assembly and a heat exchange member provided in an embodiment of the present disclosure;

FIG. 6 is an enlarged view of a part A in FIG. 5;

FIG. 7 is a partial three-dimensional schematic exploded view of a battery apparatus provided in an embodiment of the present disclosure; and

FIG. 8 is a schematic diagram of a connection structure of a barrier and a heat exchange member provided in an embodiment of the present disclosure.

### DESCRIPTION OF REFERENCE NUMERALS

10, battery layer; 11, battery cell; 111, terminal post; 12, first battery layer; 13, second battery layer; 20, box body assembly; 21, first box portion; 22, second box portion; 30, thermal management assembly; 31, heat exchange member; 311, first heat exchange plate; 3111, first surface; 312, second heat exchange plate; 3121, first matching plane; 313, protrusion; 314, medium flow channel; 315, first flange portion; 316, first flow channel group; 317, second flow channel group; 318, liquid inlet; 319, liquid outlet; 32, heating member; 33, upper cover; 331, second flange portion; 40, barrier; 50, end plate; 51, first end plate; 52, second end plate; 53,. third end plate; 54, fourth end plate; 100, battery apparatus; 200, controller; 300, motor; and 1000, vehicle.

### DETAILED DESCRIPTION

Unless otherwise specified, all implementations and optional implementations of the present disclosure may be combined with each other to form new technical solutions.

Unless otherwise specified, all technical features and optional technical features of the present disclosure may be combined with each other to form new technical solutions.

With the development of clean energy sources, more and more devices use electric energy as driving energy, and are further rapidly developed as power batteries that can store relatively much electric energy and can be charged and discharged repeatedly for multiple times, for example, lithium-ion batteries. Power batteries are not only used in energy storage power systems such as hydro, thermal, wind, and solar power stations, but also widely used in electric means of transport such as electric bicycles, electric motorcycles, and electric vehicles, and used in many other fields such as aerospace.

In the embodiments of the present disclosure, a battery cell may be a secondary battery. The secondary battery refers to a battery cell that can be used continually by activating an active material in a manner of charging after the battery cell is discharged.

The battery cell may be a lithium-ion battery, a sodium-ion battery, a sodium/lithium-ion battery, a lithium metal battery, a sodium metal battery, a lithium-sulfur battery, a magnesium-ion battery, a nickel-hydrogen battery, a nickel-cadmium battery, a lead storage battery, or the like, which is not limited in the embodiments of the present disclosure.

The battery cell generally includes an electrode assembly. The electrode assembly includes a positive electrode, a negative electrode, and a separator. The separator is disposed between the negative electrode and the positive electrode. During a charging and discharging process of the battery cell, active ions (such as lithium ions) are intercalated and deintercalated back and forth between the positive electrode and the negative electrode. The separator is disposed between the positive electrode and the negative electrode, and may play a role in preventing a short circuit between the positive electrode and the negative electrode while allowing the active ions to pass through.

The electrode assembly may be of a wound structure, a laminated structure, or a hybrid structure of wound and laminated structures.

In some implementations, the electrode assembly is of a wound structure. A positive electrode plate and a negative electrode plate are wound into the wound structure.

In some implementations, the electrode assembly is of a laminated structure.

As an example, a plurality of positive electrode plates and a plurality of negative electrode plates may be respectively provided, and the plurality of positive electrode plates and the plurality of negative electrode plates are disposed in an alternately stacked manner.

As an example, the plurality of positive electrode plates may be provided, the negative electrode plate may be folded to form a plurality of folding segments that are stacked, and one positive electrode plate is clamped between adjacent folding segments.

As an example, the positive electrode plate and the negative electrode plate are both folded to form the plurality of folding segments that are stacked.

As an example, a plurality of separators may be provided, and are respectively disposed between any adjacent positive electrode plates or negative electrode plates.

As an example, the separators may be consecutively disposed between any adjacent positive electrode plates or negative electrode plates by folding or winding.

In some implementations, a shape of the electrode assembly may be a cylindrical shape, a flat shape, a polygonal prism shape, or the like.

In some implementations, the electrode assembly is provided with a tab, and the tab may output a current from the electrode assembly. The tab includes a positive tab and a negative tab.

In some implementations, the battery cell may include a shell. The shell may be a steel shell, an aluminum shell, a plastic shell (such as polypropylene), a composite metal shell (such as a copper-aluminum composite shell), an aluminum-plastic film, or the like. In some embodiments, the shell may be of a sealed structure, or may be of an unsealed structure. As an example, when the shell is of an unsealed structure, the shell plays a role in protecting the electrode assembly. A sealed bag is further provided between the shell and the electrode assembly. The sealed bag is configured to encapsulate the electrode assembly and an electrolyte. Specifically, the sealed bag may be a bag-shaped insulating member or the aluminum-plastic film. When the shell is of the sealed structure, the shell is configured to encapsulate components such as the electrode assembly and the electrolyte.

As an example, the battery cell may be a cylindrical battery cell, a prismatic battery cell, a pouch battery cell, or a battery cell in another shape. The prismatic battery cell includes a square-shell battery cell, a blade-shaped battery cell, or a multi-prism battery. For example, the multi-prism battery may be a hexagonal prism battery, or the like. This is not particularly limited in the present disclosure.

In some implementations, the shell includes an end cover and a case. The case is provided with an opening. The opening is covered with the end cover. The case may be provided with one or a plurality of openings. One or a plurality of end covers may also be provided.

In some implementations, the shell is provided with at least one electrode terminal, and the electrode terminal is electrically connected to the tab. The electrode terminal may be directly connected to the tab, or may be indirectly connected to the tab through a current collecting member. The electrode terminal may be disposed on the end cover, or may be disposed on the case.

In some embodiments, the energy storage device includes an energy storage container, an energy storage electric cabinet, or the like.

In a new energy vehicle provided with a battery apparatus, the battery apparatus may be configured to completely or partially provide power. In a related technology, an arrangement manner of a single battery layer is used. However, a single layer of battery apparatuses may have problems of a relatively low energy density and a limited battery capacity. In addition, a relatively cold environment may cause a relatively low temperature of the battery apparatus, which may affect the cycle performance, service life, and the like of the battery apparatus.

In view of this, to increase the energy density of the battery apparatus and improve the cycle performance of the battery apparatus, an embodiment of the present disclosure provides a battery apparatus. The battery apparatus includes a box body assembly, a thermal management assembly, and a battery assembly. The battery assembly includes a plurality of battery layers stacked along a height direction of the battery apparatus. The plurality of battery layers are disposed in the box body assembly. The thermal management assembly includes a heat exchange member and a heating member. The heat exchange member has at least one medium flow channel therein. The at least one medium flow channel is configured for conduction of a heat exchange medium. The heat exchange medium is configured to perform heat exchange with the battery layer. The heat exchange member is disposed between the plurality of battery layers. The heat exchange member is configured to carry at least some of the battery layers. The heating member is disposed between the battery layer and the heat exchange member, or the heating member is disposed between the battery layer and the box body assembly.

The battery apparatus provided in this embodiment of the present disclosure includes the box body assembly, the thermal management assembly, and the battery assembly. The battery layers are disposed in the box body assembly. The box body assembly protects the battery layers. On one hand, by disposing the plurality of battery layers, it is beneficial to increasing the battery capacity of the battery apparatus. In addition, by stacking the battery layers along the height direction of the battery apparatus, it is also beneficial to fully using the space in the box body assembly, and increasing the energy density of the battery apparatus. On the other hand, by disposing the heat exchange member between the plurality of battery layers, the battery layers located on two opposite sides of the heat exchange member can exchange heat at the same time, thereby being beneficial to improving the heat exchange efficiency of the heat exchange member for the battery layers. That is, the heat exchange efficiency can also be improved while increasing the energy density of the battery apparatus. In addition, by disposing the heating member between the battery layer and the heat exchange member, or disposing the heating member between the battery layer and the box body assembly, when the battery layer needs to be heated, the heat generated by the heating member can be transferred to the battery layer, so that the battery layer can be heated under a low-temperature operating condition, thereby improving the cycle performance and service life of the battery apparatus. In addition, the structure of using the heating member to heat the battery layer is simple, and the heating apparatus does not need to be additionally disposed to heat the heat exchange medium, thereby being beneficial to simplifying the structure and reducing costs. In addition, when the heating member is disposed between adjacent battery layers, the heating member may heat the adjacent battery layers at the same time, thereby improving the heating efficiency.

The technical solution described in this embodiment of the present disclosure is suitable for a power consuming apparatus using the battery apparatus. The power consuming apparatus includes the battery apparatus according to any embodiment of the present disclosure, and the battery apparatus is configured to provide electric energy.

The power consuming apparatus may be a vehicle, a mobile phone, a portable device, a laptop, a ship, a spacecraft, an electric toy, an electric tool, and the like. The vehicles may be fuel vehicles, gas vehicles, or new energy vehicles. The new energy vehicles may be all-electric vehicles, hybrid electric vehicles, extended range electric vehicles, and the like. The spacecrafts include airplanes, rockets, space shuttles, spaceships, and the like. The electric toys include fixed or mobile electric toys, such as game consoles, electric vehicle toys, electric ship toys, and electric airplane toys. The electric tools include metal cutting electric tools, grinding electric tools, assembly electric tools, and railway electric tools, such as electric drills, electric grinders, electric wrenches, electric screw drivers, electric hammers, electric impact drills, concrete vibrators, and electric planers. The foregoing power consuming apparatus is not specifically limited in this embodiment of the present disclosure.

It should be noted that the technical solution described in this embodiment of the present disclosure is not only suitable for the battery apparatus described above, but also suitable for all power consuming apparatuses and energy storage devices including the battery apparatus. However, for the sake of brevity, the following embodiments are described by taking an electric vehicle as an example.

Referring to FIG. 1, a controller 200, a motor 300, and a battery apparatus 100 may be disposed inside a vehicle 1000. The controller 200 is configured to control the battery apparatus 100 to supply power to the motor 300. For example, the battery apparatus 100 may be disposed at the bottom, head, or tail of the vehicle 1000. The battery apparatus 100 may be configured to supply power to the vehicle 1000. For example, the battery apparatus 100 may serve as an operating power supply of the vehicle 1000, and is used in a circuit system of the vehicle 1000. For example, the battery apparatus 100 is configured for operating electricity requirements during starting, navigation, and operation of the vehicle 1000. In another embodiment of the present disclosure, the battery apparatus 100 may be configured not only as the operating power supply of the vehicle 1000, but also as a driving power supply of the vehicle 1000, so as to replace or partially replace fuel or natural gas to provide driving power for the vehicle 1000.

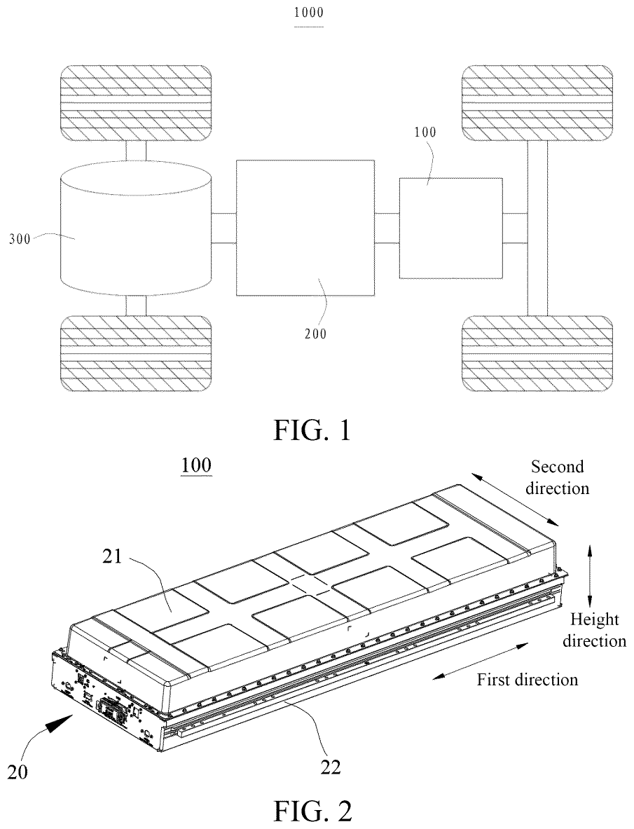

Referring to FIG. 2 to FIG. 8, an embodiment of the present disclosure provides a battery apparatus 100. The battery apparatus 100 includes a box body assembly 20, a thermal management assembly 30, and a battery assembly. The battery assembly includes a plurality of battery layers 10 stacked along a height direction of the battery apparatus 100. The plurality of battery layers 10 are disposed in the box body assembly 20. The thermal management assembly 30 includes a heat exchange member 31 and a heating member 32. The heat exchange member 31 has at least one medium flow channel 314 therein. The at least one medium flow channel 314 is configured for conduction of a heat exchange medium. The heat exchange medium is configured to perform heat exchange with the battery layer 10. The heat exchange member 31 is disposed between the plurality of battery layers 10. The heat exchange member 31 is configured to carry at least some of the battery layers 10. The heating member 32 is disposed between the battery layer 10 and the heat exchange member 31, or the heating member 32 is disposed between the battery layer 10 and the box body assembly 20.

A plurality of layers described in this embodiment of the present disclosure refer to two or more layers.

To satisfy different power usage requirements, the battery assembly of the battery apparatus 100 includes a plurality of battery layers 10 stacked in a height direction. Each of the battery layer 10 includes a plurality of battery cells 11. The battery cell 11 refers to a minimum unit constituting a battery module or a battery pack. The plurality of battery cells 11 may be connected in series, in parallel, or in series and parallel. The series-parallel connection means that the plurality of battery cells 11 are connected in both series and parallel. The plurality of battery cells 11 may be directly connected in series, in parallel, or in series and parallel, and then, the whole formed by the plurality of battery cells 11 may be accommodated in the box body assembly 20. Of course, the battery apparatus 100 may also be structured such that the plurality of battery cells 11 are first connected in series, in parallel, or in series and parallel to form battery modules, and then, a plurality of battery modules are connected in series, in parallel, or in series and parallel to form a whole which is accommodated in the box body assembly 20. The battery apparatus 100 may also include other structures, for example, the battery apparatus 100 may also include a bus component for achieving electrical connection among the plurality of battery cells 11. Each battery cell 11 may be a secondary battery or a primary battery, and may also be a lithium-sulfur battery, a sodium-ion battery, and may also be a magnesium-ion battery, but is not limited thereto. The battery cell 11 may be in a cylindrical shape, a flat shape, a cuboid shape, or any other shape.

The box body assembly 20 may be of a simple three-dimensional structure such as a single cuboid, a cylinder or a sphere, or a complex three-dimensional structure composed of simple three-dimensional structures such as a cuboid, a cylinder, or a sphere. A material of the box body assembly 20 may be aluminum alloy, iron alloy, or another alloy material, or polycarbonate, polyisocyanurate foam plastic, or another polymer material, or a composite material of glass fiber and epoxy resin.

The box body assembly 20 is configured to encapsulate the battery cells 11. The box body assembly 20 may prevent liquids or other foreign matters from affecting the charging or discharging of the battery cells 11.

Exemplarily, the box body assembly 20 generally has a cuboid structure. Both a length direction and a width direction of the box body assembly 20 are parallel to a horizontal plane. The length direction of the box body assembly 20 is parallel to the longest edge of the cuboid structure of the box body assembly 20. A height direction of the box body assembly 20 is perpendicular to the ground.

It should be noted that a specific type of the heat exchange medium is not limited here, provided that the heat exchange medium can perform a heat exchange effect on the battery cell 11. For example, the heat exchange medium may be in a gas state or a liquid state. This embodiment of the present disclosure is described by using an example in which the heat exchange medium is a cooling liquid.

It should be noted that the specific number of medium flow channels 314 is not limited here. One or a plurality of medium flow channels 314 may be provided.

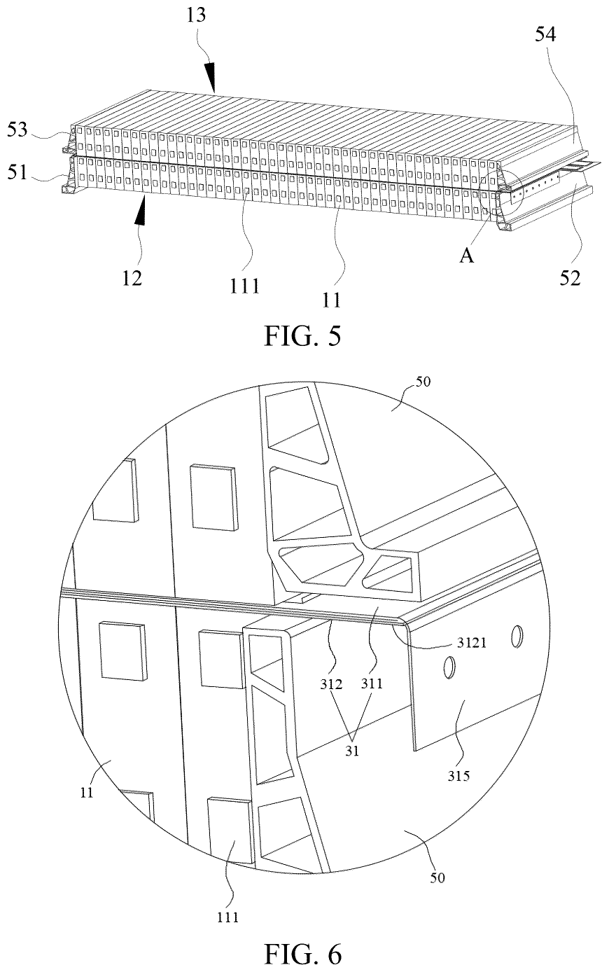

Exemplarily, referring to FIG. 5 to FIG. 6, the heat exchange member 31 includes at least two heat exchange plates. The at least two heat exchange plates are stacked to form at least one medium flow channel 314. That is, a plurality of heat exchange plates are provided.

Exemplarily, the heat exchange plate has a plate-shaped structure, and may have certain structural strength and supporting strength, thereby being beneficial to improving the overall structural strength and stability of the thermal management assembly 30.

Exemplarily, the heat exchange plate may further be stamped or welded according to requirements to form a specific structure for supporting and other functions.

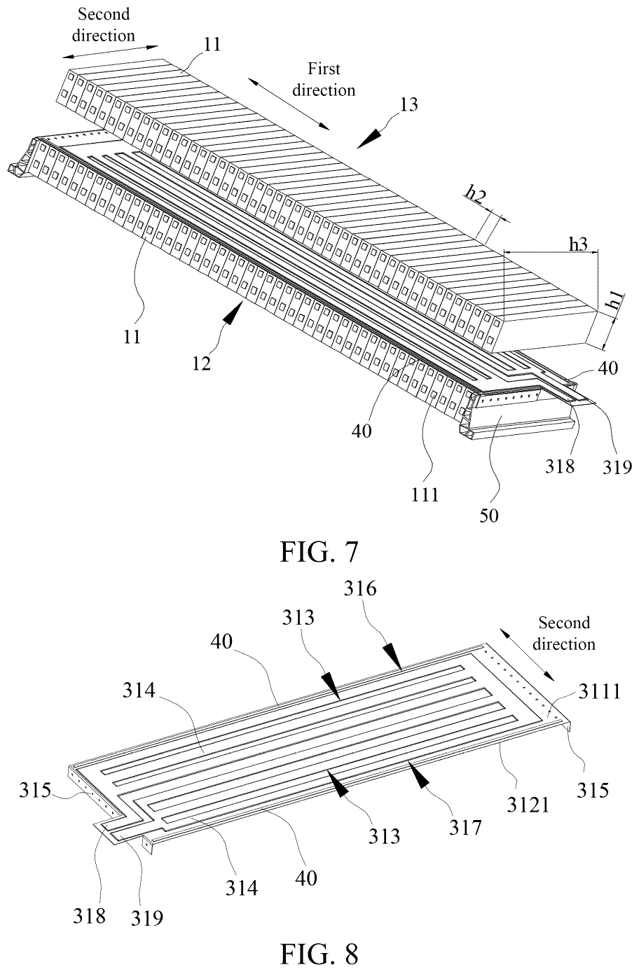

Exemplarily, referring to FIG. 7 to FIG. 8, the thermal management assembly 30 further includes a liquid inlet 318 and a liquid outlet 319. The liquid inlet 318 and the liquid outlet 319 both communicate with the medium flow channel 314.

Here, the liquid inlet 318 and the liquid outlet 319 of the thermal management assembly 30 are configured to be connected to pipelines of a liquid storage apparatus such as an air-conditioning system or a water tank of an entire vehicle or a power consuming apparatus.

The principle of using the thermal management assembly 30 to perform heat exchange of the battery cell 11 is as following: A heat exchange medium output by a heat exchange medium source (not shown in the figure) enters the medium flow channel 314 through the liquid inlet 318 of the thermal management assembly 30, and after the heat exchange medium exchanges heat with the battery cell 11, the heat exchange medium flows out of the liquid outlet 319 of the thermal management assembly 30, so as to complete the heat exchange of the battery cell 11.

Here, the process of using the thermal management assembly 30 to perform heat exchange of the battery cell 11 may be a process of performing heat dissipation of the battery cell 11, and may also be a process of heating the battery cell 11.

The principle of using the thermal management assembly 30 to perform heat dissipation of the battery cell 11 is as following: The heat exchange medium output by the heat exchange medium source enters the medium flow channel 314 through the liquid inlet 318 of the thermal management assembly 30, and after the heat exchange medium absorbs the heat generated in an operating process of the battery cell 11, the heat exchange medium flows out of the liquid outlet 319 of the thermal management assembly 30 to release heat, thereby completing cooling and heat dissipation of the battery cell 11.

The principle of using the thermal management assembly 30 to heat the battery cell 11 is as following: The heat exchange medium output by the heat exchange medium source enters the medium flow channel 314 through the liquid inlet 318 of the thermal management assembly 30, the heat exchange medium transfers the heat to the battery cell 11 to heat the battery cell 11, and then, the heat exchange medium flows out of the liquid outlet 319 of the thermal management assembly 30, thereby completing the heating of the battery cell 11.

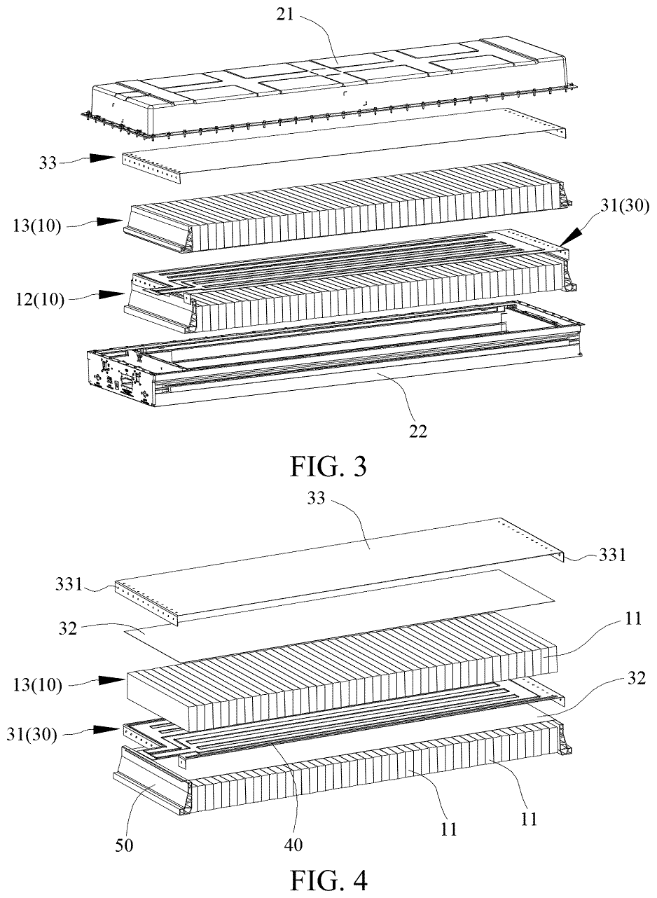

The box body assembly 20 is configured to accommodate the battery cell 11. The box body assembly 20 may have various structures. In some embodiments, referring to FIG. 2 and FIG. 3, the box body assembly 20 may include a first box portion 21 and a second box portion 22. The first box portion 21 and the second box portion 22 cover each other, so as to define an accommodating space for accommodating the battery cells 11.

In order to increase the sealing performance after connection between the first box portion 21 and the second box portion 22, a sealing member, such as a sealant or a sealing ring, may also be disposed between the first box portion 21 and the second box portion 22.

Assuming that the first box portion 21 covers a top of the second box portion 22, the first box portion 21 may also be referred to as an upper box cover, and the second box portion 22 may also be referred to as a lower box cover.

Exemplarily, at least one heat exchange plate has a protrusion 313. A medium flow channel 314 is formed in the protrusion 313.

Here, the at least one heat exchange plate has the protrusion 313, and the medium flow channel 314 is formed in the protrusion 313, that is, the protrusion 313 may be set into a required shape according to requirements, thereby being beneficial to improving the design flexibility of the medium flow channel 314.

In some implementations, referring to FIG. 8, the medium flow channel 314 includes a bent segment.

Here, a size and a path of the medium flow channel 314 may be freely designed according to a heat distribution situation or a space distribution situation of the battery cell 11. For example, the medium flow channel 314 is set to include the bent segment, thereby being beneficial to improving the heat exchange efficiency and the assembly convenience.

Exemplarily, the heat exchange plate may be stamped to form the protrusion 313.

Here, a specific material of the heat exchange plate is not limited.

In some implementations, a metal plate is set as the heat exchange plate. Exemplarily, the material of the heat exchange plate may be aluminum alloy, steel, or the like.

The materials of different heat exchange plates may be the same, or may be different.

In this embodiment, the metal plate is set as the heat exchange plate, and the metal plate not only has better structural strength, but also has better thermal conduction performance. That is, the heat exchange plate may also have certain structural strength while satisfying the situation that the heat exchange member 31 has certain heat exchange efficiency.

Exemplarily, at least two heat exchange plates are connected by welding. That is, the heat exchange plates are connected by welding to form the heat exchange member 31. In this way, it is beneficial to improving the reliability of a connection structure between the heat exchange plates.

Exemplarily, the heat exchange plates are connected by brazing.

In brazing, dissimilar metals (such as aluminum matrix composites) may be combined by a hot roll bonding process, so that the material has high mechanical strength, corrosion resistance and fatigue resistance, and is applicable to load-bearing and severe environments. Moreover, a brazed joint has better air and liquid sealing properties, and supports dissimilar connections of various metals and alloys. In addition, the size and the path of the medium flow channel 314 may be freely designed so as to be applicable to a complex scenario in which the heat source distribution is irregular or the space is limited.

The heat exchange member 31 is set to include at least two heat exchange plates, and the at least two heat exchange plates are stacked to form at least one medium flow channel 314. In this way, it is beneficial to improving the design flexibility of the heat exchange member 31. The size and the path of the medium flow channel 314 may be freely designed so as to be applicable to the complex scenario in which the heat source distribution is irregular or the space is limited, thereby being beneficial to further improving the heat exchange efficiency. In addition, at least one heat exchange plate is provided with a protrusion 313, so as to form the medium flow channel 314 in the protrusion 313, thereby being further beneficial to improving the design flexibility.

Exemplarily, the heat exchange member 31 and the battery layer 10 may be bonded by applying an adhesive, and the disposition of a barrier 40 may achieve a blocking effect on the adhesive, thereby improving the situation of adhesive overflow.

Exemplarily, referring to FIG. 5 to FIG. 8, a first surface 3111 of the heat exchange member 31 is configured to carry the battery layer 10. The barrier 40 is disposed on the first surface 3111, and the barrier 40 abuts between the battery layer 10 and the first surface 3111.

The barrier 40 abuts between the battery layer 10 and the first surface 3111, that is, the upper battery layer 10 presses the barrier 40 instead of pressing the heat exchange member 31. The barrier 40 may achieve a supporting effect, thereby avoiding the situation that the battery layer 10 crushes the medium flow channel 314 to some extent.

Exemplarily, the barrier 40 may be higher than the protrusion 313, and the medium flow channel 314 is formed in the protrusion 313, so that the upper battery layer 10 presses the barrier 40 instead of pressing the protrusion 313.

The first surface 3111 of the heat exchange member 31 is configured to carry the battery layer 10, and the barrier 40 abuts between the battery layer 10 and the first surface 3111, that is, the upper battery layer 10 presses the barrier 40, so that the barrier 40 may achieve a supporting effect, thereby improving the situation that the upper battery layer 10 presses the medium flow channel 314, further reducing the possibility that the upper battery layer 10 crushes the medium flow channel 314, and being beneficial to improving the reliability of the battery apparatus 100. In addition, the disposition of the barrier 40 may also achieve the blocking effect on the adhesive, thereby improving the situation that the adhesive overflows to the outside of the battery layer 10.

Exemplarily, the heating member 32 may be a heating film. Further, the heating member 32 may be an electric heating film.

Exemplarily, a heating resistor is provided inside the heating member 32. After the heating resistor is powered on, heat is generated, so as to heat the battery layer 10.

Referring to FIG. 4 to FIG. 6, the heating member 32 is disposed between the battery layer 10 and the heat exchange member 31, that is, the heat exchange member 31 is in contact with the battery layer 10 through the heating member 32.

When the battery layer 10 needs to be heated, the heat generated by the heating member 32 may be directly transferred to the battery layer 10, or may be transferred to the battery layer 10 through the heat exchange member 31. A material of the heat exchange member 31 may better transfer the heat generated by the heating member 32 to the battery layer 10. In this way, the heating member 32 may heat two adjacent battery layers 10 at the same time, thereby improving the heating efficiency.

When the temperature of the battery layer 10 needs to be reduced, the cooling capacity generated by the heat exchange member 31 may be directly transferred to the battery layer 10, or may be transferred to the battery layer 10 through the heating member 32 (in this case, the heating member 32 does not generate heat), so as to achieve heat dissipation of the battery layer 10.

Exemplarily, the heating member 32 may be first attached to a surface of the heat exchange member 31, and then, the heat exchange member 31 and the heating member 32 are matched with the battery layer 10, for example, fixed by applying the adhesive. Certainly, the heating member 32 may also be first attached to the battery layer 10, and then, the heat exchange member 31 and the heating member 32 are fixed to the battery layer 10 by applying the adhesive.

The battery apparatus 100 provided in this embodiment of the present disclosure includes the box body assembly 20, the thermal management assembly 30, and the battery assembly. The battery layers 10 are disposed in the box body assembly 20. The box body assembly 20 protects the battery layers 10. On one hand, by disposing the plurality of battery layers 10, it is beneficial to increasing the battery capacity of the battery apparatus 100. In addition, by stacking the battery layers 10 along the height direction of the battery apparatus 100, it is also beneficial to fully using the space in the box body assembly 20, and increasing the energy density of the battery apparatus 100. On the other hand, by disposing the heat exchange member 31 between the plurality of battery layers 10, the battery layers 10 located on two opposite sides of the heat exchange member 31 can exchange heat at the same time, thereby being beneficial to improving the heat exchange efficiency of the heat exchange member 31 for the battery layers 10. That is, the heat exchange efficiency can also be improved while increasing the energy density of the battery apparatus 100. In addition, by disposing the heating member 32 between the battery layer 10 and the heat exchange member 31, or disposing the heating member 32 between the battery layer 10 and the box body assembly 20, when the battery layer 10 needs to be heated, the heat generated by the heating member 32 can be transferred to the battery layer 10, so that the battery layer 10 can be heated under a low-temperature operating condition, thereby improving the cycle performance and service life of the battery apparatus. In addition, the structure of using the heating member to heat the battery layer is simple, and the heating apparatus does not need to be additionally disposed to heat the heat exchange medium, thereby being beneficial to simplifying the structure and reducing costs. In addition, when the heating member 32 is disposed between adjacent battery layers 10, the heating member 32 may heat the adjacent battery layers 10 at the same time, thereby improving the heating efficiency.

Here, there are various situations where at least one heat exchange plate has a protrusion 313.

In some implementations, referring to FIG. 5 to FIG. 8, the heat exchange member 31 includes at least two heat exchange plates. The heat exchange plates include a first heat exchange plate 311 and a second heat exchange plate 312. A protrusion 313 is formed by protruding from some regions of the first heat exchange plate 311. The first heat exchange plate 311 and the second heat exchange plate 312 are stacked. The medium flow channel 314 is defined between the protrusion 313 and the second heat exchange plate 312.

That is, only some regions of the first heat exchange plate 311 need to be protruded to form the protrusion 313, and the second heat exchange plate 312 does not need to form the protrusion 313, thereby being beneficial to reducing the process of forming the protrusion 313 on the second heat exchange plate 312 and reducing the positioning difficulty between the first heat exchange plate 311 and the second heat exchange plate 312, and being beneficial to increasing the production efficiency.

In some other embodiments, some regions of the first heat exchange plate 311 and some regions of the second heat exchange plate 312 are both protruded to form protrusions 313.

Exemplarily, the first heat exchange plate 311 is disposed above the second heat exchange plate 312. In this way, the first heat exchange plate 311 has a first surface 3111.

In some implementations, the first surface 3111 is a surface of a side of the first heat exchange plate 311 facing away from the second heat exchange plate 312.

Here, the protrusion 313 of the first heat exchange plate 311 and the protrusion 313 of the second heat exchange plate 312 may be disposed opposite to each other, so that a medium flow channel 314 is formed around the protrusion 313 of the first heat exchange plate 311 and the protrusion 313 of the second heat exchange plate 312. Alternatively, the protrusion 313 of the first heat exchange plate 311 and the protrusion 313 of the second heat exchange plate 312 are disposed in a staggered manner, so that a medium flow channel 314 is formed around the protrusion 313 of the first heat exchange plate 311 and a non-protrusion of the second heat exchange plate 312, and a medium flow channel 314 is formed around the protrusion 313 of the second heat exchange plate 312 and a non-protrusion of the first heat exchange plate 311.

In some implementations, referring to FIG. 5 to FIG. 6, the plurality of battery layers 10 include a first battery layer 12 and a second battery layer 13 adjacently disposed. The second battery layer 13 is located above the first battery layer 12. A first matching plane 3121 is formed on a side of the heat exchange member 31 facing the first battery layer 12. The heating member 32 is disposed between the first matching plane 3121 and the first battery layer 12.

Exemplarily, the first matching plane 3121 is formed on a side of the second heat exchange plate 312 facing away from the first heat exchange plate 311. The first matching plane 3121 faces the first battery layer 12. The first heat exchange plate 311 faces the second battery layer 13.

In addition to the first battery layer 12 and the second battery layer 13, the plurality of battery layers 10 may further include another battery layer 10, for example, may further include a third battery layer 10. The third battery layer 10 may be located below the first battery layer 12, or may be located above the second battery layer 13.

The heat exchange member 31 is disposed between the first battery layer 12 and the second battery layer 13.

Here, the first heat exchange plate 311 and the second heat exchange plate 312 are stacked. The first heat exchange plate 311 is located above the second heat exchange plate 312. The first matching plane 3121 is formed on a side of the second heat exchange plate 312 facing away from the first heat exchange plate 311. That is, the first matching plane 3121 is configured to be matched with the first battery layer 12, and the protrusion 313 is disposed on a side of the heat exchange member 31 facing the second battery layer 13.

In this embodiment, the first matching plane 3121 is formed on the side of the heat exchange member 31 facing the first battery layer 12 and the heating member 32 is disposed between the first matching plane 3121 and the first battery layer 12. In this way, the heating member 32 may be better matched with the first battery layer 12 and the heat exchange member 31.

Exemplarily, the heating member 32 is attached to the first matching plane 3121.

That is, the heating member 32 may be first attached to the first matching plane 3121 to form a pre-assembled member of the heating member 32 and the heat exchange member 31, and then, the pre-assembled member and the first battery layer 12 are matched, for example, fixed by applying the adhesive.

Certainly, the heating member 32 may also be attached to the first battery layer 12 first to form a pre-assembled member of the heating member 32 and the first battery layer 12, and then, the pre-assembled member and the heat exchange member 31 are fixed by applying the adhesive.

Here, the heating member 32 is attached to the first matching plane 3121 to facilitate the disposition of the heating member 32, so that the heating member 32 is better attached to the heat exchange member 31.

In some implementations, referring to FIG. 7 to FIG. 8, the heat exchange member 31 includes a first flow channel group 316 and a second flow channel group 317. The first flow channel group 316 includes a liquid inlet 318 and at least one medium flow channel 314. The second flow channel group 317 includes a liquid outlet 319 and at least one medium flow channel 314. One end of the medium flow channel 314 of the first flow channel group 316 communicates with the liquid inlet 318, one end of the medium flow channel 314 of the second flow channel group 317 communicates with the liquid outlet 319, and one end of the medium flow channel 314 of the first flow channel group 316 far away from the liquid inlet 318 communicates with one end of the medium flow channel 314 of the second flow channel group 317 far away from the liquid outlet 319.

That is, the heat exchange medium flows from the liquid inlet 318 into the medium flow channel 314 of the first flow channel group 316, then flows into the medium flow channel 314 of the second flow channel group 317, and flows out of the liquid outlet 319.

In an embodiment in which the first flow channel group 316 includes a plurality of medium flow channels 314, a same end of the plurality of medium flow channels 314 of the first flow channel group 316 communicates with the liquid inlet 318.

In an embodiment in which the second flow channel group 317 includes a plurality of medium flow channels 314, a same end of the plurality of medium flow channels 314 of the second flow channel group 317 communicates with the liquid outlet 319.

In this embodiment, by setting the heat exchange member 31 to include the first flow channel group 316 and the second flow channel group 317, enabling the medium flow channel 314 of the first flow channel group 316 to communicate with the liquid inlet 318, and enabling the medium flow channel 314 of the second flow channel group 317 to communicate with the liquid outlet 319, a size and a path of the medium flow channel 314 may be freely designed according to a heat distribution situation or a space distribution situation of the battery cell 11, thereby being beneficial to further increasing the heat exchange efficiency.

In some implementations, referring to FIG. 5 to FIG. 8, each of the battery layer 10 includes a plurality of battery cells 11 arranged along a first direction. The medium flow channel 314 extends along the first direction. The first flow channel group 316 and the second flow channel group 317 are arranged along a second direction. The first direction intersects with the second direction.

Here, the liquid inlet 318 and the liquid outlet 319 may be located on a same side of the heat exchange member 31 along the first direction, or may be located on different sides of the heat exchange member 31 along the first direction.

In this embodiment, an arrangement direction of the battery cells 11 is set to be the same as an extension direction of the medium flow channel 314, thereby being beneficial to improving the heat exchange uniformity, and further improving the temperature uniformity of the battery cells 11.

In some implementations, referring to FIG. 6 to FIG. 8, a size h1 of the battery cell 11 along a height direction of the battery apparatus 100 and a size h2 of the battery cell 11 along a first direction are smaller than a size h3 of the battery cell 11 along a second direction. The first direction, the second direction, and the height direction of the battery apparatus 100 intersect with each other. The size of the battery cell 11 along the second direction is in a range from 300 mm to 1200 mm.

The size of the battery cell 11 along the second direction may be any one or a range value between any two values of 300 mm, 350 mm, 400 mm, 450 mm, 500 mm, 560 mm, 600 mm, 650 mm, 700 mm, 780 mm, 800 mm, 830 mm, 860 mm, 900 mm, 950 mm, 1000 mm, 1050 mm, 1100 mm, 1150 mm, and 1200 mm.

Here, h1, h2, and h3 may be measured by using a measurement tool such as a vernier caliper in an ordinary temperature state before the battery apparatus 100 is used.

It should be noted that h1, h2, and h3 do not include the sizes of a terminal post 111 and/or a pressure relief structure, that is, h1, h2, and h3 may be acquired by measuring a size of the shell of the battery cell 11.

In this embodiment, the size of the battery cell 11 along the second direction is set to be in a range from 300 mm to 1200 mm, so that both the battery capacity and assembly efficiency of the battery apparatus 100 can be considered.

Exemplarily, the battery cell 11 in this embodiment may be a blade battery having a long and thin shape.

The size of the battery cell 11 along the height direction of the battery apparatus 100 may be greater than the size of the battery cell 11 along the first direction, or the size of the battery cell 11 along the height direction of the battery apparatus 100 may be less than the size of the battery cell 11 along the first direction.

It can be understood that the battery cells 11 can be conveniently stacked along the first direction, and the battery cells 11 can also be conveniently stacked along the height direction. That is, the number of the battery cells 11 can be increased in the first direction and the height direction, so as to increase the battery capacity of the battery apparatus 100.

In some implementations, referring to FIG. 7 to FIG. 8, the battery cell 11 further includes a terminal post 111 and/or a pressure relief structure. The terminal post 111 and/or the pressure relief structure is disposed on at least one side of the battery cell 11 along the second direction. The first direction, the second direction, and the height direction of the battery apparatus 100 intersect with each other.

It can be understood that the battery cells 11 of the battery layer 10 are arranged along the first direction, and the battery layers 10 are stacked along the height direction of the battery apparatus 100. Therefore, it is inconvenient to dispose the terminal post 111 and/or the pressure relief structure in the first direction and the height direction of the battery apparatus 100. For example, by disposing the terminal post 111 and/or the pressure relief structure in the first direction or the height direction of the battery apparatus 100, the terminal post 111 and/or the pressure relief structure needs to be avoided, which is not beneficial to improving the structural compactness.

In this way, when the battery cells 11 are stacked along the first direction, the terminal post 111 is disposed on a side of the battery cell 11, so as to electrically connect a plurality of battery cells 11 to implement series and/or parallel connection. It should be noted that the terminal post 111 includes a positive terminal post 111 and a negative terminal post 111. During a charging and discharging process of the battery, the positive terminal post 111 and the negative terminal post 111 are electrically connected to form a current loop, or positive terminal posts 111 and/or negative terminal posts 111 of a plurality of battery cells 11 may be electrically connected to implement series and/or parallel connection.

In this embodiment, by disposing the terminal post 111 and/or the pressure relief structure on the at least one side of the battery cell 11 along the second direction, on one hand, it is beneficial to improving the structural compactness of the battery apparatus 100, and on the other hand, it is also beneficial to reducing the damage to the terminal post 111 and/or the pressure relief structure in a process of stacking battery cells 11 and/or battery layers 10.

In some implementations, referring to FIG. 5 to FIG. 8, along the second direction, the first flow channel group 316 is closer to the terminal post 111 and/or the pressure relief structure than the second flow channel group 317.

Here, the medium flow channel 314 of the first flow channel group 316 communicates with the liquid inlet 318, and the medium flow channel 314 of the second flow channel group 317 communicates with the liquid outlet 319. During a process of heat exchange, the heat exchange medium first flows through the medium flow channel 314 of the first flow channel group 316 and then flows through the medium flow channel 314 of the second flow channel group 317. In this way, the temperature of the medium flow channel 314 in the first flow channel group 316 is relatively lower than that of the medium flow channel 314 in the second flow channel group 317. The temperature of one end of the battery cell 11 close to the terminal post 111 and/or the pressure relief structure is relatively higher than the temperature of one end far away from the terminal post 111 and/or the pressure relief structure. In this way, the first flow channel group 316 is set to be closer to the terminal post 111 and/or the pressure relief structure than the second flow channel group 317, thereby being beneficial to increasing the heat exchange efficiency, and increasing the temperature uniformity of the battery cell 11.

In some implementations, referring to FIG. 7 to FIG. 8, each of the battery layer 10 includes a plurality of battery cells 11 arranged along the first direction. A barrier 40 is disposed on at least one side of the protrusion 313 along the second direction. The first direction, the second direction, and the height direction of the battery apparatus 100 intersect with each other.

The barrier 40 may be disposed on one side of the protrusion 313 along the second direction, or the barrier 40 may be disposed on both sides of the protrusion 313 along the second direction.

Certainly, the barrier 40 may also be disposed at a middle position of the protrusion 313. For example, the barrier 40 is disposed at a gap between adjacent medium flow channels 314.

Exemplarily, the barrier 40 extends along the first direction.

In this embodiment, the barrier 40 is disposed on at least one side of the protrusion 313 along the second direction, so as to achieve a blocking effect on the adhesive, thereby further improving the situation of adhesive overflow.

In some implementations, referring to FIG. 7 to FIG. 8, barriers 40 are disposed on both sides of the protrusion 313 along the second direction. The two barriers 40 are respectively supported at two ends of the battery cell 11 along the second direction.

That is, the two barriers 40 are respectively located on an outer side of the protrusion 313 along the second direction, thereby being further beneficial to improving the situation of adhesive overflow. In addition, by respectively supporting the two barriers 40 at two ends of the battery cell 11 along the second direction, it is beneficial to improving the supporting effect of the barriers 40 for the battery cell 11, and further reducing the possibility that the upper battery layer 10 crushes the medium flow channel 314, thereby further improving the reliability of the battery apparatus 100.

In some implementations, referring to FIG. 5 to FIG. 8, each of the battery layer 10 includes a plurality of battery cells 11 arranged along the first direction. The battery assembly further includes at least one end plate 50. The end plate 50 is disposed at the at least one end of the battery layer 10 along the first direction. The at least one end of the heat exchange member 31 along the first direction is connected to the end plate 50. The first direction intersects with the height direction of the battery apparatus 100.

One or a plurality of end plates 50 may be provided.

The battery layer 10 may be provided with the end plate 50 at one end along the first direction, and the other end may abut against a side wall of the box body assembly 20. The battery layer 10 may also be provided with end plates 50 at both ends along the first direction.

In an embodiment in which the end plates 50 are disposed at both ends of the battery layer 10 along the first direction, both ends of the heat exchange member 31 along the first direction are connected to the end plates 50.

Here, the end plate 50 is configured to constrain the battery layer 10 in the first direction, and is configured to at least bear an expansion force of the battery cell 11. The expansion force here specifically refers to an acting force applied to the box body assembly 20 due to expansion and deformation of the battery cell 11. As an example, the end plate 50 mainly bears the expansion force along the first direction.

In some related technologies, the end plate 50 is also referred to as an expanded beam.

A specific structure and a material of the end plate 50 are not limited. As an example, the end plate 50 may have a beam-like structure, and the end plate 50 may be made of any suitable material, such as a metal material, a polymer material, or a composite material.

A specific connection manner between the heat exchange member 31 and the end plate 50 is not limited, and may be tight connection, clamping, or welding, so as to transmit the force received by the heat exchange member 31 to the end plate 50.

Exemplarily, referring to FIG. 3, the box body assembly 20 includes a frame and a bottom wall. The frame is disposed along an edge of the bottom wall. The frame and the bottom wall together enclose an accommodating space. The end plate 50 is connected to the frame. It can be understood that the heat exchange member 31 can transmit the received force to the end plate 50, and the end plate 50 can transmit the received force to the frame. That is, the frame can provide support to the end plate 50, and the end plate 50 can provide support to the heat exchange member 31.

Exemplarily, two ends of the end plate 50 along the second direction are connected to the frame.

Exemplarily, the end plate 50 may be connected to the frame first, and then, the battery layer 10 is assembled; or the end plate 50 and the battery layer 10 may be assembled together first, and then, the pre-assembled member of the end plate 50 and the battery layer 10 is assembled to the frame.

In this embodiment, the end plate 50 is disposed at the at least one end of the battery layer 10 along the first direction and the at least one end of the heat exchange member 31 along the first direction is connected to the end plate 50. In this way, it is beneficial for the heat exchange member 31 to transmit the received force to the frame through the end plate 50, beneficial to improving the supporting strength for the battery layer 10, and beneficial to reducing the possibility of extruding and damaging a lower battery layer 10 caused by excessively stacked battery layers 10, thereby increasing the battery capacity of the battery apparatus 100 and improving the reliability of the battery apparatus 100.

In some implementations, referring to FIG. 3 to FIG. 5, the plurality of battery layers 10 include a first battery layer 12 and a second battery layer 13. The second battery layer 13 is located above the first battery layer 12. The end plate 50 includes a first end plate 51 and a second end plate 52 that are oppositely disposed along the first direction. The first battery layer 12 is disposed between the first end plate 51 and the second end plate 52. Two ends of the heat exchange member 31 along the first direction are respectively connected to the first end plate 51 and the second end plate 52.

That is, the heat exchange member 31 disposed between the first battery layer 12 and the second battery layer 13 is connected to the first end plate 51 and the second end plate 52 corresponding to the first battery layer 12. In other words, the heat exchange member 31 is connected to the end plate 50 corresponding to the battery layer 10 located below.

In some implementations, referring to FIG. 3 to FIG. 5, the end plate 50 includes a third end plate 53 and a fourth end plate 54 that are oppositely disposed along the first direction. The second battery layer 13 is disposed between the third end plate 53 and the fourth end plate 54. Two ends of the heat exchange member 31 along the first direction are respectively connected to the third end plate 53 and the fourth end plate 54.

That is, the heat exchange member 31 disposed between the first battery layer 12 and the second battery layer 13 is connected to the third end plate 53 and the fourth end plate 54 corresponding to the second battery layer 13. In other words, the heat exchange member 31 is connected to the end plate 50 corresponding to the battery layer 10 located above.

Here, the heat exchange member 31, the third end plate 53, the fourth end plate 54, and the second battery layer 13 are formed into a whole, and then are stacked on another battery layer 10, thereby being beneficial to improving the overall structural strength of the battery apparatus 100.

In some other embodiments, the heat exchange member 31 may be connected to the first end plate 51, the second end plate 52, the third end plate 53, and the fourth end plate 54 at the same time.

Certainly, in some other embodiments, the battery layer 10 is configured to carry the heat exchange member 31 located above.

That is, the weight of the heat exchange member 31 is supported on the battery layer 10, that is, the battery layer 10 is configured to carry the heat exchange member 31 located above.

In some implementations, the battery assembly includes a mounting bracket. The mounting bracket is connected to the box body assembly 20. The heat exchange member 31 is connected to the mounting bracket.

Exemplarily, the mounting bracket is connected to the bottom wall of the box body assembly 20.

Exemplarily, the mounting bracket is connected to the frame of the box body assembly 20.

In some implementations, referring to FIG. 7, a first flange portion 315 is formed at the at least one end of the heat exchange member 31 along the first direction. The first flange portion 315 is connected to the end plate 50.

The first flange portion 315 may be formed at one end of the heat exchange member 31 along the first direction, or the first flange portion 315 may be formed at both ends of the heat exchange member 31 along the first direction.

That is, the heat exchange member 31 is folded towards the end plate 50 to form the first flange portion 315, and is connected to the end plate 50 through the first flange portion 315. The connection structure is simple and reliable, and is convenient to be formed.

In some implementations, referring to FIG. 3 to FIG. 4, the heating member 32 is disposed on a top of the uppermost battery layer 10.

In this way, the top of the uppermost battery layer 10 is heated, thereby further improving the reliability of the battery apparatus 100.

In some implementations, referring to FIG. 3 to FIG. 4, the thermal management assembly 30 further includes an upper cover 33. The upper cover 33 is disposed on the top of the uppermost battery layer 10. The heating member 32 is disposed between the upper cover 33 and the uppermost battery layer 10.

That is, the heating member 32 may be first attached to a surface of the upper cover 33 to form a pre-assembled member of the heating member 32 and the upper cover 33, and then, the pre-assembled member and the uppermost battery layer 10 are matched, for example, fixed by applying the adhesive.

Certainly, the heating member 32 and the uppermost battery layer 10 may also be attached to each other first to form a pre-assembled member of the heating member 32 and the uppermost battery layer 10, and then, the pre-assembled member and the upper cover 33 are fixed by applying the adhesive.

In this embodiment, the upper cover 33 is disposed, and the heating member 32 is disposed between the upper cover 33 and the uppermost battery layer 10, so as to facilitate the disposition of the heating member 32, so that the heating member 32 is better attached to the heat exchange member 31, and the heating member 32 may be protected, thereby improving the reliability of the thermal management assembly 30.

In some implementations, referring to FIG. 3 to FIG. 4, a second flange portion 331 is formed at the at least one end of the upper cover 33 along the first direction. The second flange portion 331 is connected to the end plate 50.

The second flange portion 331 may be formed at one end of the upper cover 33 along the first direction, or the second flange portion 331 may be formed at both ends of the upper cover 33 along the first direction.

That is, the upper cover 33 is folded towards the end plate 50 to form the second flange portion 331, and is connected to the end plate 50 through the second flange portion 331. The connection structure is simple and reliable, and is convenient to be formed.

A specific connection manner between the second flange portion 331 and the end plate 50 is not limited, and may be tight connection, clamping, or welding. The connection structure is simple and reliable.

In the description of the present disclosure, the description of the reference terms “an embodiment”, “in some embodiments”, “in some other embodiments”, “in yet another embodiments”, “exemplarily”, and the like means that specific features, structures, materials, or characteristics described in combination with this embodiment or example are included in at least one embodiment or example of the present disclosure. In the present disclosure, schematic descriptions of the foregoing terms are not necessarily directed at the same embodiment or example. Moreover, the described specific features, structures, materials, or characteristics may be combined in proper manners in any one or more embodiments or examples. In addition, those skilled in the art may combine different embodiments or examples described in the present disclosure and features of the different embodiments or examples as long as they are not contradictory to each other.

The foregoing descriptions are merely exemplary embodiments of the present disclosure, but are not intended to limit the present disclosure. The present disclosure may include various modifications and changes for those skilled in the art. Any modification, equivalent replacement, or improvement made within the spirit and principle of the present disclosure shall fall within the protection scope of the present disclosure.

What is claimed is:

1. A battery apparatus, comprising:
a box body assembly;
a battery assembly, the battery assembly comprising a plurality of battery layers stacked along a height direction of the battery apparatus, and the plurality of battery layers being disposed in the box body assembly; and
a thermal management assembly, the thermal management assembly comprising a heat exchange member and a heating member, the heat exchange member having at least one medium flow channel therein, the at least one medium flow channel being configured for conduction of a heat exchange medium, and the heat exchange medium being configured to perform heat exchange with the battery layer, wherein
the heat exchange member is disposed between the plurality of battery layers, and the heat exchange member is configured to carry at least some of the battery layers; and the heating member is disposed between the battery layer and the heat exchange member, or the heating member is disposed between the battery layer and the box body assembly.

2. The battery apparatus according to claim 1, wherein the plurality of battery layers comprise a first battery layer and a second battery layer adjacently disposed, and the second battery layer is located above the first battery layer; and
a first matching plane is formed on a side of the heat exchange member facing the first battery layer, and the heating member is disposed between the first matching plane and the first battery layer.

3. The battery apparatus according to claim 2, wherein the heating member is attached to the first matching plane.

4. The battery apparatus according to claim 2, wherein the heat exchange member comprises at least two heat exchange plates, the heat exchange plates comprise a first heat exchange plate and a second heat exchange plate, a protrusion is formed by protruding from some regions of the first heat exchange plate, the first heat exchange plate and the second heat exchange plate are stacked, the medium flow channel is defined between the protrusion and the second heat exchange plate, and the first matching plane is formed on a side of the second heat exchange plate facing away from the first heat exchange plate.

5. The battery apparatus according to claim 1, wherein each of the battery layers comprises a plurality of battery cells arranged along a first direction, the battery assembly further comprises at least two end plates, the end plates are respectively disposed at two ends of the battery layer along the first direction, two ends of the heat exchange member along the first direction are both connected to the end plates, and the first direction intersects with the height direction of the battery apparatus.

6. The battery apparatus according to claim 5, wherein first flange portions are formed at two ends of the heat exchange member along the first direction, and the first flange portions are connected to the end plates.

7. The battery apparatus according to claim 5, wherein the heat exchange member is tightly connected, clamped, or welded to the end plate.

8. The battery apparatus according to claim 1, wherein the heating member is disposed on a top of the uppermost battery layer.

9. The battery apparatus according to claim 8, wherein the thermal management assembly further comprises an upper cover, the upper cover is disposed on the top of the uppermost battery layer, and the heating member is disposed between the upper cover and the uppermost battery layer.

10. The battery apparatus according to claim 9, wherein each of the battery layers comprises the plurality of battery cells arranged along the first direction, the battery assembly further comprises the at least two end plates, and the end plates are respectively disposed at the two ends of the battery layer along the first direction; and
second flange portions are formed at two ends of the upper cover along the first direction, and the second flange portions are connected to the end plates.

11. The battery apparatus according to claim 10, wherein the second flange portion is tightly connected, clamped, or welded to the end plate.

12. The battery apparatus according to claim 1, wherein each of the battery layers comprises the plurality of battery cells arranged along the first direction, a size of the battery cell along the height direction of the battery apparatus and a size of the battery cell along the first direction are smaller than a size of the battery cell along a second direction, the first direction, the second direction, and the height direction of the battery apparatus intersect with each other, and the size of the battery cell along the second direction is in a range from 300 mm to 1200 mm.

13. The battery apparatus according to claim 1, wherein each of the battery layers comprises the plurality of battery cells arranged along the first direction, the battery cell further comprises a terminal post and/or a pressure relief structure, the terminal post and/or the pressure relief structure is disposed on at least one side of the battery cell along the second direction, and the first direction, the second direction, and the height direction of the battery apparatus intersect with each other.

14. A power consuming apparatus, comprising the battery apparatus according to claim 1.
